(19) United States
(12) Patent Application Publication
(10) Pub. No.: US 2012/0056999 A1
(43) Pub. Date: Mar. 8, 2012

(54) IMAGE MEASURING DEVICE AND IMAGE MEASURING METHOD

(75) Inventor: Hirohisa Handa, Kawasaki-shi (JP)

(73) Assignee: MITUTOYO CORPORATION, Kawasaki-shi (JP)

(21) Appl. No.: 13/225,859

(22) Filed: Sep. 6, 2011

(30) Foreign Application Priority Data
Sep. 7, 2010 (JP) 2010-199556

(51) Int. Cl. H04N 13/02; G06K 9/00; H04N 7/18

(52) U.S. Cl. 348/48; 348/135; 382/154; 348/E07.085; 348/E13.074

(57) ABSTRACT

An image measuring device comprises an imaging unit; and an processing unit operative to treat image information obtained at the imaging unit by imaging a measurement object and compute coordinate information on the measurement object from the image information. The processing unit includes an error correcting unit operative to apply the error information inherent in the imaging unit to correct the image information obtained at the imaging unit by imaging the measurement object, thereby obtaining corrected image information, and a coordinate computing unit operative to compute coordinate information on the measurement object from the corrected image information.

### CROSS-REFERENCE TO RELATED APPLICATION

This application is based upon and claims the benefit of priority from the prior Japanese Patent Application No. 2010-199556, filed on Sep. 7, 2010, the entire contents of which are incorporated herein by reference.

### BACKGROUND OF THE INVENTION

1. Field of the Invention

The present invention relates to an image measuring device and image measuring method capable of computing coordinate information on a measurement object from image information.

2. Description of the Related Art

The previously known 3-dimensional measuring systems use markers such as light-emitting members and reflecting members (hereinafter, markers) or lasers to form light-emitting spots or lines on the surface of the measurement object, then image the light-emitting surface at plural image sensors, and measure the position or shape of the measurement object from plural pieces of image information taken at the plural image sensors (for example, JP 2002-505412A, JP 2002-510803A, JP 2001-506762A, and JP 2005-233759A). Such the 3-dimensional measuring systems derive the measurement coordinates basically through geometric operational processing based on the principle of triangulation. Therefore, they are possible to have simpler device structures and achieve faster measurements.

These 3-dimensional measuring systems cause errors due to various factors, such as the aberration and image multiplication error caused on the lens in the image sensors at the time of image taking, and the attachment error and angular error caused at the time of assembling the image measuring device, which lower the measurement accuracy as a problem.

For the purpose of solving such the problem, it is required to previously acquire a three-dimensional correction table of the physical positions of the markers associated one to one with pieces of image information on that positions taken at plural image sensors and, at the time of normal measurement, check pieces of image data from the image sensors against the three-dimensional correction table, thereby determining the coordinate values of the measurement object in a proposed method. The three-dimensional correction table can be acquired as follows. First, it is required to set the marker and so forth to emit light on the known point within a measurement range of the image measuring device and acquire pieces of image information on that position at plural image sensors. This operation is repeated over the entire zone within the measurement range of the image measuring device. Such the method makes it possible to achieve measurements with higher accuracy than the conventional method, independent of the aberration of the lens and the accuracy of assembling the image measuring device.

In the method with the three-dimensional correction table, it is essentially required to include the operation of acquiring the three-dimensional correction table over the entire measurement range at the time of completion of assembling the image measuring device. The operation of acquiring the three-dimensional correction table is an operation to obtain correlations between the positions on the taken image and the physical measurement positions. Therefore, it is required to use another three-dimensional correction table capable of sufficiently covering an actual measurement range.

The three-dimensional correction table is acquired using a specific lens at a specific magnification. Therefore, if the measurement lens is exchanged or the magnification is changed, it is required to acquire a three-dimensional correction table again in a state after exchanging the lens or changing the magnification. Therefore, it is not possible to exchange the lens during the operation of measuring and use a scaling-device equipped lens such as a zoom lens. Thus, it is not possible to select arbitrarily the measurement range, the resolution, the operable distance and so forth.

When the measurement is executed using the three-dimensional correction table, it is impossible to execute arbitrary modifications to the measurement system, such as the baseline length and the camera angle (an angle formed between the directions of image taking at 2 cameras: a convergence angle), because the relation between the positions and the directions of image taking of the image sensors are fixed.

The present invention has been made in consideration of such the point and has an object to provide a high-flexibility image measuring device and image measuring method.

### SUMMARY OF THE INVENTION

An image measuring device according to the present invention comprises an imaging unit; and an processing unit operative to treat image information obtained at the imaging unit by imaging a measurement object and compute coordinate information on the measurement object from the image information, wherein the processing unit includes an error correcting unit operative to apply the error information inherent in the imaging unit to correct the image information obtained at the imaging unit by imaging the measurement object, thereby obtaining corrected image information, and a coordinate computing unit operative to compute coordinate information on the measurement object from the corrected image information.

The above configuration makes it possible to compute accurate coordinate positions through geometric computations by previously applying correction processing to the image information, thereby executing high-flexibility measurements provided for the exchange of a measurement lens, the use of a zoom lens and so forth, the modifications to the baseline length and the camera angle, and so forth.

In the image measuring device according to one embodiment of the present invention, the imaging unit may comprises plural such image sensors, wherein the processing unit computes three-dimensional coordinate information on the measurement object from plural pieces of image information obtained at the plural image sensors by individually imaging the measurement object.

In the image measuring device according to one embodiment of the present invention, the error correcting unit may include a two-dimensional correction table holding error information on two-dimensional coordinates caused by the aberration of the optical system in the image sensors, the error on image taking such as the image magnification error, and mechanical errors such as the position and the viewing angle of the image sensors, as the error information inherent in the imaging unit, and a correction operating unit operative to refer to the two-dimensional correction table and correct the image information on the measurement object taken at the plural image sensors to obtain the corrected image information.

In the image measuring device according to one embodiment of the present invention, the imaging unit may include a first camera arranged to image the measurement object and acquire one-dimensional image information extending in the vertical direction by making the images of the measurement object intensive in the horizontal direction, and a second and a third camera arranged separately in the horizontal direction to image the measurement object and acquire one-dimensional image information extending in the horizontal direction by making the images of the measurement object intensive in the vertical direction, wherein the processing unit computes coordinate information on the measurement object in the vertical direction using the first camera, and computes coordinate information on the measurement object in the horizontal plane using the second and third cameras.

In the image measuring device according to one embodiment of the present invention, the imaging unit also includes a scaling device, wherein the error correcting unit executes error correction processing corresponding to the variation in magnification of the imaging unit desirably.

In the image measuring device according to one embodiment of the present invention, the imaging unit may further include changeable parts, wherein the changeable parts include an optical system, and a storage device holding the error information inherent in the optical system.

An image measuring method according to one embodiment of the present invention comprises a first step of imaging a measurement object at an imaging unit; a second step of correcting the image information obtained at the imaging unit using the error information inherent in the imaging unit, thereby obtaining corrected image information, and a third step of computing coordinate information on the measurement object from the corrected image information.

### BRIEF DESCRIPTION OF THE DRAWINGS

FIG. 1 is an overall diagram of an image measuring device according to a first embodiment of the present invention.

FIGS. 2A and 2B are diagrams showing a specific configuration of an imaging unit in the same device.

FIGS. 3A and 3B are diagrams showing an example of the internal structure of a camera in the same device.

FIGS. 4A and 4B are block diagrams illustrative of operation of an processing unit in the same device.

FIG. 5 is a diagram showing errors containing distortions inherent in the imaging unit in the same device.

FIG. 6 is a diagram showing the state at the time of recording error information inherent in the imaging unit in the same device.

FIG. 7 is a flowchart showing a method example at the time of recording error information inherent in the imaging unit in the same device.

FIGS. 8A and 8B are diagrams illustrative of operation of a coordinate computing unit in the same device.

FIG. 9 is an overall diagram of an image measuring device according to a second embodiment of the present invention.

### DETAILED DESCRIPTION OF THE EMBODIMENTS

The following detailed description is given to an image measuring device and image measuring method according to a first embodiment of the present invention.

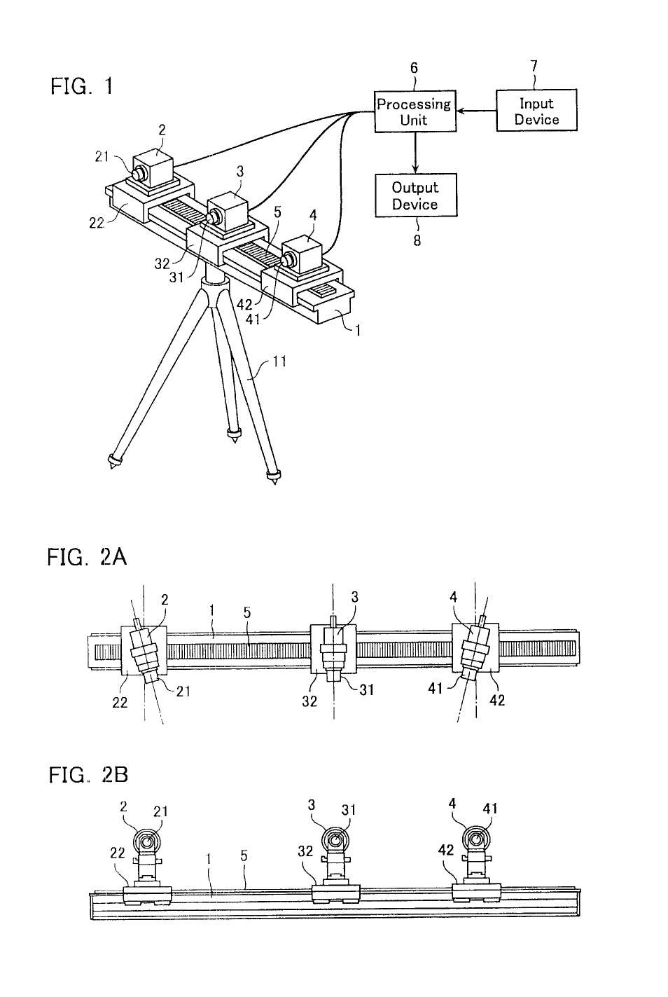

FIG. 1 is an overall diagram of the image measuring device according to the present embodiment. A rail-shaped base 1, supported on a tripod 11 and arranged facing a measurement space and extending laterally, is used to support an imaging unit composed of three image sensors 2-4 having respective lenses facing the measurement space and arranged in the longitudinal direction of the base 1 movable in the longitudinal direction of the base 1. The base 1 includes a linear encoder 5, which is used to measure the positions of the image sensors 2-4 in the longitudinal direction of the base 1. The information on images taken at the image sensors 2-4, the information on the positions of the image sensors 2-4 acquired at the linear encoder 5, the angles of later-described cameras 21 and 41 from the reference position, and so forth are fed to an processing unit 6 for use in operational processing. The processing unit 6 is connected to an input device 7 operative to input the measurement condition and so forth, and an output device 8 operative to output the operation result. These processing unit 6, input device 7 and output device 8 can be configured with a computer and computer-executable programs.

FIGS. 2A and 2B are diagrams showing a further specific configuration of the imaging unit in the image measuring device according to the present embodiment. The image sensors 2-4 include cameras 21, 31, 41, and movable mounts 22, 32, 42 arranged movably on the base 1 used to hold the cameras 21, 31, 41 thereon, respectively. The cameras 21, 31 and 41 are arranged on the movable mounts 22, 32 and 42 rotatable in the horizontal plane. The movable mounts 22, 32 and 42 include rotary encoders, not shown, to measure the angles of the cameras 21, 31 and 41 from the reference position. Movements and rotations of the cameras 21, 31, 41 can be executed manually though they can be executed in batch with the motor power and the like under control by the processing unit 6. The central camera 31 may be fixed.

In the present embodiment, the cameras 21, 41 are used to take one-dimensional images in the horizontal direction of a measurement object, not shown, and the camera 31 is used to take a one-dimensional image in the vertical direction of the measurement object. These three pieces of one-dimensional image information are applied to compute three-dimensional coordinate values of the measurement object, thereby making a larger reduction in the quantity of information possibly.

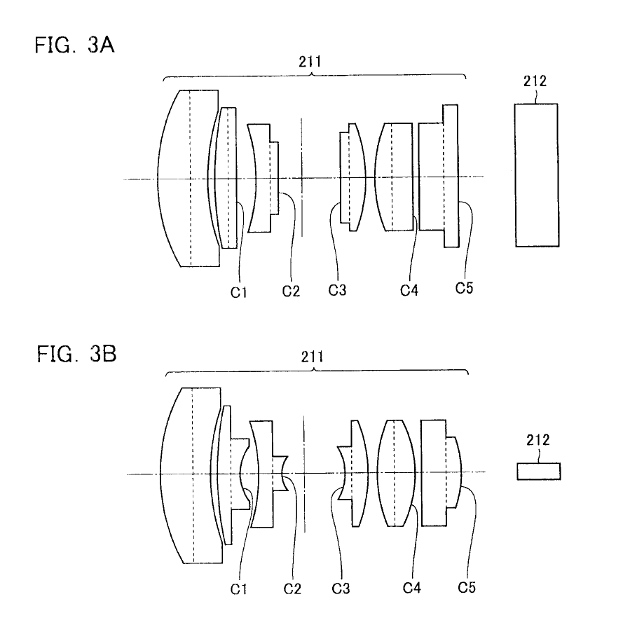

FIGS. 3A and 3B are diagrams showing an example of the internal structure of the camera 21 in the image measuring device according to the present embodiment. FIG. 3A shows a plan view, and 3B shows a side view. The camera 21 includes an anamorphic lens 211, and a line. CCD (hereinafter, LCCD) sensor 212. The anamorphic lens 211 has cylindrical surfaces C1-C5 to make the image of the measurement object intensive in the perpendicular direction. The image of the measurement object made intensive in the perpendicular direction is received at the photo-sensing surface of the LCCD sensor 212 and acquired as one-dimensional image information extending in the horizontal direction.

The camera 41 has the same configuration. In contrast, the camera 31 is arranged in such a state that the optical system (the anamorphic lens 211 and the LCCD sensor 212) is rotated 90° about the optical axis so as to acquire one-dimensional image information extending in the perpendicular direction by making the images of the measurement object intensive in the horizontal direction.

Next, the processing unit 6 is described.

The processing unit 6 uses two pieces of one-dimensional image information in the horizontal direction and one piece of one-dimensional image information in the vertical direction taken at the above-described three cameras 21, 31, 41 to derive three-dimensional coordinates of measurement points of the measurement object arranged in the measurement space, that is, the image-taking space based on the principle of triangulation. In practice, however, errors due to various factors, such as the aberration and image multiplication error caused on the lens in the imaging unit at the time of taking images, and the attachment error and angular error caused at the time of assembling the image measuring device make it difficult to achieve high-accuracy measurements.

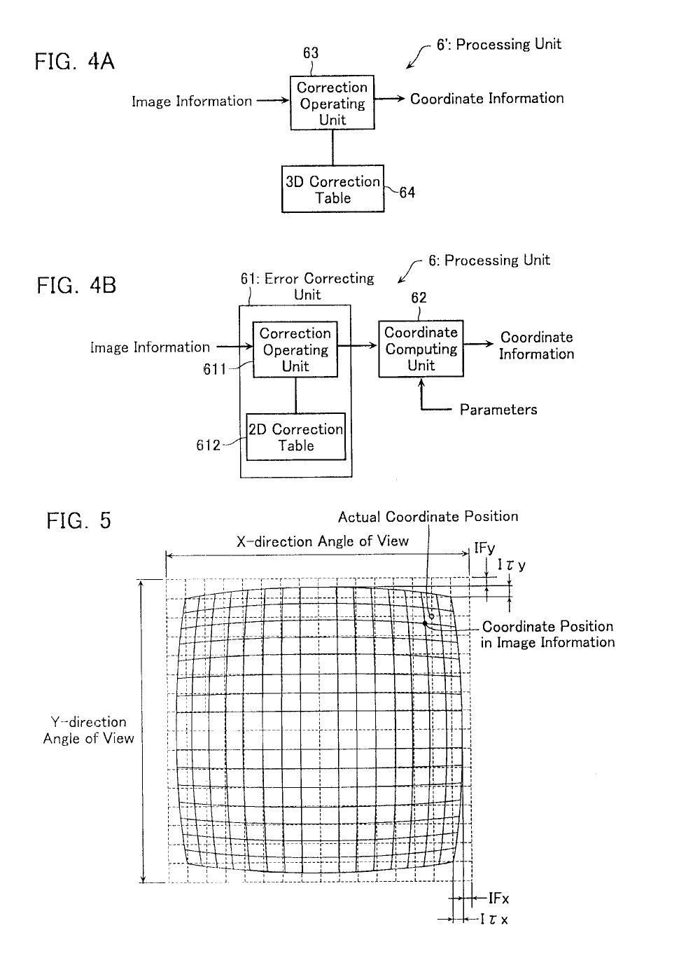

Therefore, a 3D correction table 64 is created to show the relation between the image information and the associated coordinate values in the measurement space, for example, as shown in FIG. 4A. In addition, a correction processing unit 63 is used to compute the coordinates from the image information with reference to the 3D correction table 64. Such the configuration can be considered. In this case, it is required to previously create the 3D correction table 64 so as to show the relation between coordinates in the measurement space and the associated image information. Specifically, plural known points in the measurement space are used to emit light as the markers, and images of the markers are taken at the plural cameras 21, 31, 41 to acquire one-dimensional image information. This operation is repeated over the entire zone in the measurement space, thereby creating the 3D correction table 64 as shown in FIG. 4A.

This method, however, requires the use of another three-dimensional measuring system for providing coordinate values in the measurement space accurately. In addition, it is required to create a new 3D correction table every time when the Lenses in the cameras 21, 31, 41 are exchanged. Further, it is impossible to execute scaling using a zoom lens or changing the positions and angles of the cameras 21, 31, 41.

Therefore, in the present embodiment, the error information inherent in the image sensors 2-4 is used in the processing unit 6 to correct the image information obtained at the image sensors 2-4 so as to previously bring the image information for use in triangulation into a state of no error contained, and then coordinate information on the measurement object is computed based on the parameters such as the magnifications, positions and camera angles of the cameras 21, 31, 41. In this case, the part that is changed at the time of lens exchange is only the inherent error information (later-described two-dimensional correction table 612).

FIG. 4B is a block diagram showing the configuration of the processing unit 6 in the image measuring device according to the present embodiment. The processing unit 6 according to the present embodiment includes an error correcting unit 61 and a coordinate computing unit 62. The error correcting unit 61 contains a two-dimensional correction table 612 holding error information on two-dimensional coordinates caused by the aberration of the optical system in the image sensors 2-4, the error on image taking such as the image magnification error, and mechanical errors such as the position and the viewing angle of the image sensors 2-4, as the error information inherent in the imaging unit. It also includes a correction operating unit 611 operative to correct the image information on the measurement object taken at the image sensors 2-4 with reference to the two-dimensional correction table 612 to obtain corrected image information.

FIG. 5 shows the relation between an actual image and an image taken at the image sensors 2-4 under a large influence of distortions. FIG. 5 shows the actual coordinates in the portion illustrated with the dotted lines and the taken image in the portion illustrated with the solid lines. Between both, there are such errors that become larger toward the edges of the angles of view. The associated relations between the coordinates contained in such the actual image and the image taken through the image sensors 2-4 are stored in the two-dimensional correction table 612.

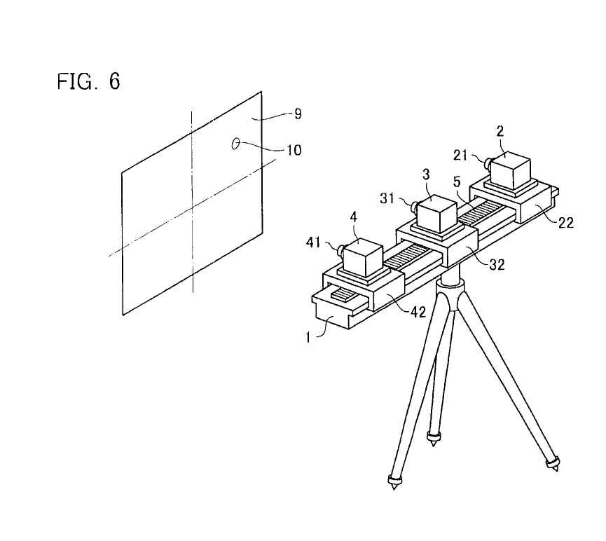

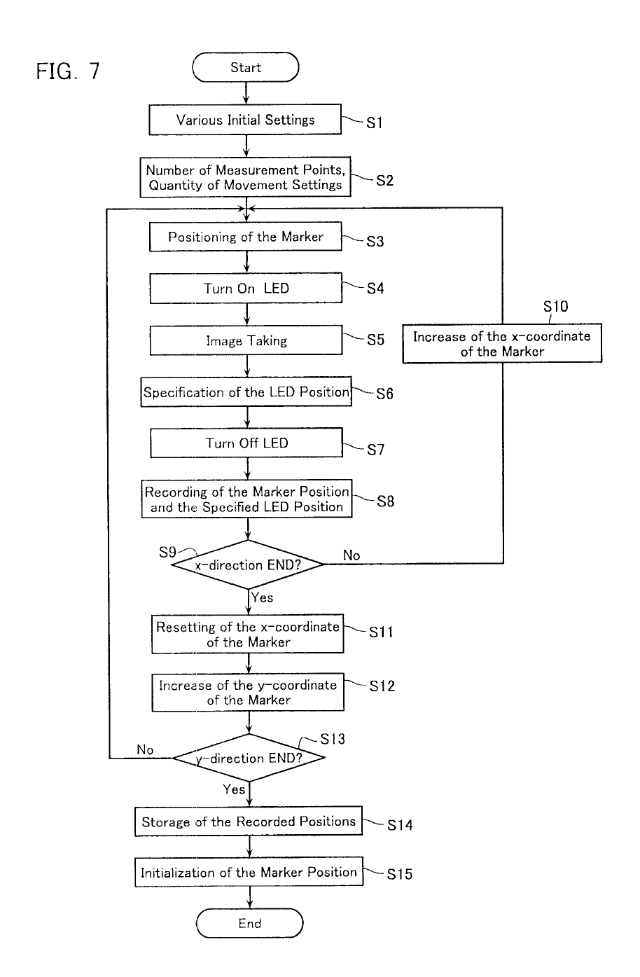

The following description is given to a method of acquiring the two-dimensional correction table 612 in the present embodiment. FIG. 6 shows a error recording system that records error information inherent in the image sensors 2-4 to acquire the two-dimensional correction table 612 in the image measuring device according to the present embodiment. FIG. 7 shows a flowchart of the error recording. In FIG. 6, an XY stage 9 is arranged in the directions of image taking at the image sensors 2-4 according to the present embodiment. A light-emitting element 10 such as an LED is attached as a marker to a moving member of the XY stage 9. At the time of acquiring the two-dimensional correction table 612, the flow first determines various initial settings, and sets the number of measurement points and the quantity of movement required for acquiring the two-dimensional correction table 612 (S1, S2). Next, the flow shifts the light-emitting element 10 to an appropriate measurement position (S3), then turns on the light-emitting element 10 (S4), and acquires image information at the image sensors 2-4 (S5). The flow specifies the position of the light-emitting element 10 within the image from the acquired image information (S6), then turns off the light-emitting element 10 (S7) such that the position of the light-emitting element 10 (coordinates) in the XY stage 9 and the position of the light-emitting element 10 within the image are associated with each other and stored into the two-dimensional correction table 612 (S8). The movement of the light-emitting element 10 in the x-axis direction and image taking at the image sensors 2-4, and the acquirement of the image information and of the coordinate information of the light-emitting element 10 are executed over all x coordinates on each y coordinate (S12, S13). Finally, the flow saves the acquired two-dimensional correction table 612 in a file (S14), then shifts the XY stage 9 to the initial position (S15), and terminates the acquirement of the two-dimensional correction table 612.

When the error recording is executed, whole environment of the error recording system may be made dark, for example. In accordance with such the method, only the bright spot of the light-emitting element 10 comes up within a dark visual field. Therefore, the use of the center-of-gravity position detecting algorithm or the like makes it possible to easily and accurately specify the coordinate position on the image information of the light-emitting element 10. If infrared is used as the light-emitting element 10, an infrared band-pass filter or the like attached in front of the lens makes it possible to improve the detection accuracy.

In the present embodiment, the XY stage is used to acquire the two-dimensional correction table 612. Instead, a large-size screen and laser beams may be used to acquire the two-dimensional correction table 612. In addition, a display such as an LCD display can be used for the same purpose to provide bright spots and dark spots at arbitrary positions on the display as objects. Further, the creation of the two-dimensional correction table 612 corresponds to the measurement of the property of the optical system in each image sensors 2-4. It does not require three pieces of image sensors 2-4 arranged all. Instead, the image sensors 2-4 may be used separately to acquire images for creation of the two-dimensional correction table 612.

The conventional technology uses a three-dimensional correction table and accordingly requires the acquirement of error information on three-dimensional coordinates over the entire image taking range. In contrast, the present embodiment is sufficient to acquire just error information on two-dimensional coordinates in a certain plane. Therefore, it is made possible to acquire a correction table in a shorter time than the conventional method.

Next, operation of the processing unit 6 at the time of image taking is described. The image information obtained at the image sensors 2-4 by imaging the measurement object and fed to the error correcting unit 61 is received at the correction operating unit 611. The correction operating unit 611 checks the input image information against the error information on two-dimensional coordinates inherent in the image sensors 2-4 contained in the two-dimensional correction table 612, and provides the corresponding positions on two-dimensional coordinates as corrected image information. The coordinate computing unit 62 applies geometric computations to the corrected image information fed from the error correcting unit 61 to compute coordinate information on the measurement object.

Next, specific operation of the error correcting unit 61 is described. As shown in FIG. 5, errors occur between the positions of the measurement object in the image information and the actual coordinate positions. The two-dimensional correction table 612 has a record of the errors at every coordinate position. At the time of measurement, the two-dimensional correction table 612 receives the coordinate position in the taken image information from the correction operating unit 611, and provides the actual coordinate position corresponding to the input coordinate position to the correction operating unit 611. The previously acquired error information on two-dimensional coordinates is discrete data on the positional coordinates. Intermediate positions can be obtained through interpolation in accordance with the distances from the positional coordinates of which values have been already acquired.

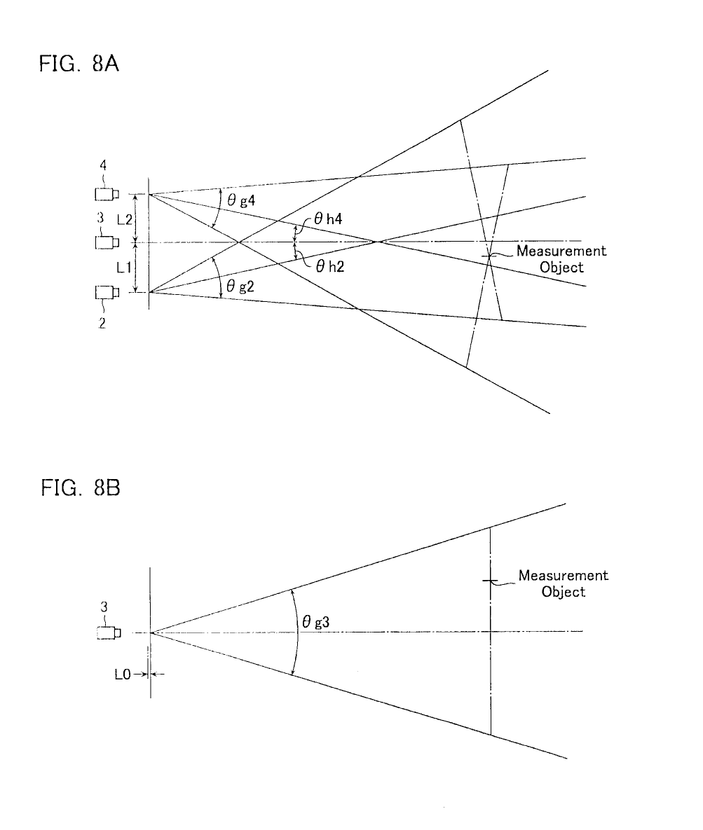

Next, operation of the coordinate computing unit 62 is described. FIGS. 8A and 8B are diagrams illustrative of operation of the coordinate computing unit 61 in the image measuring device according to the present embodiment. FIG. 8A shows ranges of image taking at the image sensors 2 and 4 in the horizontal plane, and FIG. 8B shows a range of image taking at the image sensor 3 in the perpendicular direction.

For geometric computations, parameters are defined as follows.
Res2, Res3, Res4: The numbers of effective pixels in the image sensors 2, 3, 4
θh2, θh4: The camera angles of the image sensors 2 and 4 acquired at rotary encoders
θg2, θg3, θg4: The angles of view of the image sensors 2, 3, 4
L1, L2: The distances of the image sensor 3 from the image sensors 2 and 4 acquired at the linear encoder 5
L0: The distance of the image sensor 3 in the direction of image taking from the line that links between the image sensors 2 and 4
Pos2, Pos3, Pos4: The pixel positions of the measurement object acquired at the image sensors 2, 3, 4

In Pos2-4, the central position of the image information taken at the image sensors 2-4 is assumed 0.

The parameters thus defined provide representations of the coordinate positions of the measurement object as follows.

$$x = \frac{bf - ce}{ae - bd} \\ y = \frac{af - cd}{bd - ae} \\ z = \frac{{Pos}_{3} [ 2 ( y - {L}_{0} ) Tan ( π \frac{{θ}_{g 3}}{360} ) ]}{{Res}_{3}} \qquad [ Expression 1 ]$$

In this case, a-f in the equations can be represented as follows.

$$a = [ - {Res}_{2} Cos ( π \frac{{θ}_{h 2}}{180} ) + 2 {Pos}_{2} Sin ( π \frac{{θ}_{h 2}}{180} ) Tan ( π \frac{{θ}_{g 2}}{360} ) ] \\ b = [ {Res}_{2} Sin ( π \frac{{θ}_{h 2}}{180} ) + 2 {Pos}_{2} Cos ( π \frac{{θ}_{h 2}}{180} ) Tan ( π \frac{{θ}_{g 2}}{360} ) ] \\ c = [ - {L}_{1} {Res}_{2} Cos ( π \frac{{θ}_{h 2}}{180} ) + 2 {L}_{1} {Pos}_{2} Sin ( π \frac{{θ}_{h 2}}{180} ) Tan ( π \frac{{θ}_{g 2}}{360} ) ] \\ d = [ - {Res}_{4} Cos ( π \frac{{θ}_{h 4}}{180} ) + 2 {Pos}_{4} Sin ( π \frac{{θ}_{h 4}}{180} ) Tan ( π \frac{{θ}_{g 4}}{360} ) ] \\ e = [ {Res}_{4} Sin ( π \frac{{θ}_{h 4}}{180} ) + 2 {Pos}_{4} Cos ( π \frac{{θ}_{h 4}}{180} ) Tan ( π \frac{{θ}_{g 4}}{360} ) ] \\ f = [ - {L}_{2} {Res}_{4} Cos ( π \frac{{θ}_{h 4}}{180} ) + 2 {L}_{2} {Pos}_{4} Sin ( π \frac{{θ}_{h 4}}{180} ) Tan ( π \frac{{θ}_{g 4}}{360} ) ] \qquad [ Expression 2 ]$$

Such the method makes it possible to compute coordinate positions of the measurement object through geometric computations, without the use of a three-dimensional correction table, by previously applying correction processing to the image information taken at the image sensors 2-4, thereby executing high-flexibility measurements provided for the exchange of a measurement lens, the use of a zoom lens and so forth, the modifications to the baseline length and the camera angle, and so forth.

In such the configuration, part or the entire of the anamorphic lens 211 may be configured detachable with screw mounts, bayonet mounts or the like. If part of the anamorphic lens 211 is configured changeable, the anamorphic lens is functionally divided, for example, into two parts: a general image-taking lens and an anamorphic conversion optical system, either of which may be configured changeable. In this case, the anamorphic conversion lens can be attached to the front of the general image-taking lens or to the rear thereof.

The anamorphic lens 211 may adopt a zoom lens as a scaling device. In this case, the magnification of the anamorphic lens 211 may be scaled by a motor in accordance with the input given from the input device 7 to the processing unit 6.

If the measurement lens is configured changeable, the measurement lens may be equipped with a storage device holding the error information inherent in the measurement lens, for example. Then, at the time of exchanging the measurement lens, the error information is read out to the processing unit 6 and stored in the two-dimensional correction table 612.

The above description is given to the complementing method using the two-dimensional correction table 612. If it is assumed that the error information on two-dimensional coordinates can be represented by high-degree polynomials, and a method of identifying data is used to create an approximation formula, the formula can be used to correct the error information on two-dimensional coordinates. An example of the method is shown below.

Prior to the computation, several parameters are defined. The angle of view of the lens in the x-axis direction is defined as Iθx, and the angle of view in the y-axis direction as Iθy. The actual coordinates of the measurement object are defined as (x1, y1), and the coordinates in the acquired image information as (x2, y2). In the x-axis direction, the quantity of aberration caused depending on the x-axis angle of view is defined as IFx, and the quantity of aberration caused depending on the y-axis angle of view as Irx. In the y-axis direction, the quantity of aberration caused depending on the y-axis angle of view is defined as IFy, and the quantity of aberration caused depending on the x-axis angle of view as Iry.

The x-axis aberration coefficient is defined as in Expression 3 and the mutual coefficient as in Expression 4. The y-axis aberration coefficient is defined as in Expression 5 and the mutual coefficient as in Expression 6.

$$\begin{matrix}{Ikf}_{x} = \frac{{IF}_{x}}{I {θ}_{x}^{3}} & [ Expression 3 ] \\ {Ikr}_{x} = \frac{{Ir}_{x}}{I {θ}_{x}^{1} I {θ}_{y}^{2}} & [ Expression 4 ] \\ {Ikf}_{y} = \frac{{IF}_{y}}{I {θ}_{y}^{3}} & [ Expression 5 ] \\ {Ikr}_{y} = \frac{{Ir}_{y}}{I θ {y}^{1} I θ {x}^{2}} & [ Expression 6 ]\end{matrix}$$

The actual positional coordinates (x1, y1) and the coordinates (x2, y2) in the acquired image information have relations therebetween, which are represented as in Expression 7.

x₂=x₁+Ikfₓx₁³+Ikrₓx₁y₁²

y₂=y₁+Ikf_{y}y₁³+Ikr_{y}y₁x₁² [Expression 7]

The relations between the actual positional coordinates (x1, y1) and the coordinates (x2, y2) in the acquired image information are represented as in Expression 8, and the inverse function thereof is derived as in Expression 9.

(x₂,y₂)=F(x₁,y₁) [Expression 8]

(x₁,y₁)=F⁻¹(x₂,y₂) [Expression 9]

The use of Expression 9 thus obtained makes it possible to compute the actual positional coordinates (x1, y1) of the measurement object from the coordinates (x2, y2) in the acquired image information.

### Second Embodiment

The following detailed description is given to an image measuring device and image measuring method according to a second embodiment of the present invention. The previous embodiment uses three image sensors 2-4 each operative to acquire image information in a one-dimensional direction. In contrast, the present embodiment uses two image sensors each operative to acquire image information in two-dimensional directions.

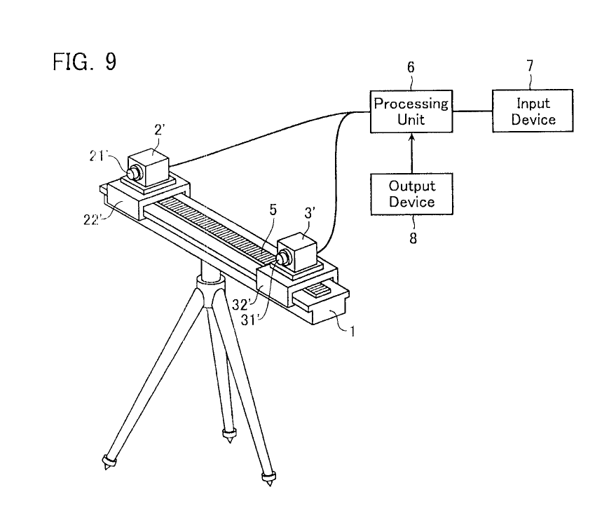

FIG. 9 is an overall diagram of the image measuring device according to the present embodiment. The basic configuration is same as the embodiment 1. Different from the previous embodiment, two image sensors 2′ and 3′ are arranged facing the respective lenses toward the measurement space and movable in the longitudinal direction of the base 1, instead of three image sensors 2-4 arranged in the longitudinal direction of the base 1. In the present embodiment, cameras 21′ and 31′ inside the image sensors 2′ and 3′ are used to individually take two-dimensional images of a measurement object, not shown, and the two pieces of two-dimensional image information are applied to compute three-dimensional coordinate values of the measurement object.

The second embodiment increases the quantity of image information processed though it can reduce the number of image sensors used.

### Third Embodiment

The following detailed description is given to an image measuring device and image measuring method according to a third embodiment of the present invention.

The basic configuration is same as the embodiments 1 and 2. In the present embodiment, an image sensor 4′ is arranged moveable in the longitudinal direction of the base 1. A camera 41′ inside the image sensor 4′ may be either a camera for acquiring two-dimensional images or a camera for acquiring one-dimensional images. In the present embodiment, the image sensor 4′ moves in parallel in the longitudinal direction of the base 1 to take images at appropriate positions. If a camera for taking one-dimensional images is used as the camera 41′, it is required to rotate the camera 41′ just 90° about the optical axis at the time of taking images in the perpendicular direction.

The camera 41′ may contain plural optical systems 411′ and a single optical sensor 412′ inside. In such the configuration, it is preferable to apply the processing unit 6 or the like to select one from the optical systems 411′ in turn, which uses the optical sensor 412′ for photo-sensing. It is also possible to assign the optical systems 411′ to the photo-sensing surfaces of the optical sensors 412′ for photo-sensing at the same time.

1. An image measuring device, comprising:
an imaging unit (2-4); and
a processing unit (6) operative to treat image information obtained at said imaging unit (2-4) by imaging a measurement object and compute coordinate information on the measurement object from the image information, characterized in that said processing unit (6) includes
an error correcting unit (61) operative to apply the error information inherent in said imaging unit (2-4) to correct the image information obtained at said imaging unit (2-4) by imaging the measurement object, thereby obtaining corrected image information, and
a coordinate computing unit (62) operative to compute coordinate information on the measurement object from said corrected image information.

2. The image measuring device according to claim 1, wherein said imaging unit comprises plural image sensors (2-4),
wherein said processing unit (6) computes three-dimensional coordinate information on the measurement object from plural pieces of image information obtained at said plural image sensors (2-4) by individually imaging the measurement object.

3. The image measuring device according to claim 2, wherein said error correcting unit (61) includes
a two-dimensional correction table (612) holding error information on two-dimensional coordinates caused by the aberration of the optical system in said image sensors (2-4), the error on image taking such as the image magnification error, and mechanical errors such as the position and the viewing angle of said image sensors (2-4), as the error information inherent in said imaging unit (2-4), and
a correction operating unit (611) operative to correct the image information on the measurement object taken at said plural image sensors (2-4) with reference to said two-dimensional correction table (612) to obtain said corrected image information.

4. The image measuring device according to claim 2, wherein said coordinate computing unit (62) computes three-dimensional coordinate information on the measurement object based on said corrected image information, the distances between said plural image sensors (2-4), and the camera angle, the number of effective pixels and the angle of view of each image sensor (2-4).

5. The image measuring device according to claim 1, wherein said imaging unit (2-4) includes
a first camera (31) arranged to image the measurement object and acquire one-dimensional image information extending in the vertical direction by making the images of the measurement object intensive in the horizontal direction, and
a second and a third camera (21, 41) arranged separately in the horizontal direction to image the measurement object and acquire one-dimensional image information extending in the horizontal direction by making the images of the measurement object intensive in the vertical direction,
wherein said processing unit (6) computes coordinate information on the measurement object in the vertical direction using said first camera (31), and computes coordinate information on the measurement object in the horizontal plane using said second and third cameras (21, 41).

6. The image measuring device according to claim 1, wherein said imaging unit (2-4) also includes a scaling device,
wherein said error correcting unit (61) executes error correction processing corresponding to the variation in magnification of said imaging unit.

7. The image measuring device according to claim 1, wherein said imaging unit (2-4) further includes changeable parts,
wherein said changeable parts include
an optical system (211), and
a storage device holding the error information inherent in said optical system (2-4)

8. An image measuring method of taking images of a measurement object at imaging unit (2-4) and computing coordinate information on said measurement object from the obtained image information, characterized by:
a first step of imaging said measurement object at an imaging unit (2-4);
a second step of correcting the image information obtained at said imaging unit (2-4) using the error information inherent in said imaging unit (2-4), thereby obtaining corrected image information, and
a third step of computing coordinate information on the measurement object from said corrected image information.

9. The image measuring method according to claim 8, wherein the first step includes imaging the measurement object at plural image sensors (2-4),
wherein the third step includes computing three-dimensional coordinate information on the measurement object from plural pieces of image information obtained at said plural image sensors (2-4) by individually imaging the measurement object at the first step.

10. The image measuring method according to claim 9, wherein the third step includes computing three-dimensional coordinate information on the measurement object based on said corrected image information, the distances between said plural image sensors (2-4), and the camera angle, the number of effective pixels and the angle of view of each image sensor (2-4).

11. The image measuring method according to claim 9, wherein the second step includes
referring to a two-dimensional correction table (612) holding error information on two-dimensional coordinates caused by the aberration of an optical system in said image sensors (2-4), the error on image taking such as the image magnification error, and mechanical errors such as the position and the viewing angle of said image sensors, as the error information inherent in said image sensors (2-4), and correcting the image information on the measurement object taken at said plural image sensors (2-4) to compute said corrected image information.

12. The image measuring method according to claim 8, wherein the first step includes using, as said imaging unit (2-4),
a first camera (31) arranged to image the measurement object and acquire one-dimensional image information extending in the vertical direction by making the images of the measurement object intensive in the horizontal direction, and
a second and a third camera (21, 41) arranged separately in the horizontal direction to image the measurement object and acquire one-dimensional image information extending in the horizontal direction by making the images of the measurement object intensive in the vertical direction,
wherein the second step includes
computing coordinate information on the measurement object in the vertical direction using said first camera (31), and computing coordinate information on the measurement object in the horizontal plane using said second and third cameras (21, 41).

13. The image measuring method according to claim 8, wherein said imaging unit (2-4) includes a scaling device,
wherein the second step includes executing error correction processing corresponding to the variation in magnification of said imaging unit (2-4).

14. The image measuring method according to claim 8, wherein said imaging unit (2-4) includes changeable parts,
wherein said changeable parts include
an optical system (211), and
a storage device holding the error information inherent in said optical system,
wherein the second step includes applying the error information inherent in said imaging unit (2-4) held in said storage means to correct the image information obtained at said imaging unit (2-4), thereby obtaining corrected image information.

15. An image measuring device, comprising:
an image sensor (2-4); and
a processing unit (6) electrically connected to said image sensor (2-4),
wherein said processing unit (6) includes
an error correcting unit (61), said error correcting unit containing a two-dimensional correction table (612) holding error information on two-dimensional coordinates as the error information inherent in said image sensor (2-4), and a correction operating unit (611) operative to correct the image information taken at said image sensor with reference to said two-dimensional correction table to obtain corrected image information, and
a coordinate computing device (62) operative to compute coordinate information on the measurement object from said corrected image information.

16. The image measuring device according to claim 15, wherein said image measuring device comprises plural such image sensors (2-4),
wherein said processing unit (6) computes three-dimensional coordinate information on the measurement object from plural pieces of image information obtained at said plural image sensors (2-4) by individually taking the images of the measurement object.

17. The image measuring device according to claim 15, wherein said coordinate computing unit (62) computes three-dimensional coordinate information on the measurement object based on said corrected image information, the distances between said plural image sensors, and parameters such as the camera angle, the number of effective pixels and the angle of view of each image sensor.

18. The image measuring device according to claim 15, wherein said image sensor (2-4) includes
a first camera (31) arranged to image the measurement object and acquire one-dimensional image information extending in the vertical direction by making the images of the measurement object intensive in the horizontal direction, and
a second and a third camera (21, 41) arranged separately in the horizontal direction to image the measurement object and acquire one-dimensional image information extending in the horizontal direction by making the images of the measurement object intensive in the vertical direction,
wherein said processing unit (6) computes coordinate information on the measurement object in the vertical direction using said first camera (31), and computes coordinate information on the measurement object in the horizontal plane using said second and third cameras (21, 41).

19. The image measuring device according to claim 15, wherein said image sensor (2-4) also includes a scaling device,
wherein said error correcting unit executes error correction processing corresponding to the adjusted magnification of said image sensor.

20. The image measuring device according to claim 15, wherein said error information on two-dimensional coordinates as the error information inherent in said image sensor (2-4) is caused by the aberration of the optical system in said image sensor, the error on image taking such as the image magnification error, and mechanical errors such as the position and the viewing angle of said image sensor.
